(19) United States
(12) Patent Application Publication
(10) Pub. No.: US 2009/0127041 A1
(43) Pub. Date: May 21, 2009

(54) Vibration damper with amplitude selective damping force

(75) Inventors: Manfred Denner, Massbach (DE); Michael-Johann Doppernas, Priesendorf (DE); Thomas Hammer, Bischofsheim (DE); Matthias Planitzer, Rothlein (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/291,440

(22) Filed: Nov. 10, 2008

(30) Foreign Application Priority Data
Nov. 8, 2007 (DE) 10 2007 053 160.7

(51) Int. Cl. F16F 9/508

(52) U.S. Cl. 188/282.1

(57) ABSTRACT

Vibration damper with amplitude-selective damping force that includes a piston rod, which is guided with freedom of axial movement in a damping medium-filled cylinder. The piston rod carries a piston arrangement, which divides the cylinder into a working space on the side of the piston with the piston rod and a working space on the side of the piston opposite the piston rod, where a flow connection, which, as a function of the movement of the piston rod, determines a damping force by means of a switching ring, which moves axially between two stop surfaces, in conjunction with at least one axially movable valve ring in a switching ring groove. The switching ring cooperates with one stop surface to form the boundaries of an annular space adjacent to the working space on the piston rod side and with another stop surface to form the boundary of an annular space adjacent to the working space on the side of the piston opposite the piston rod. The axial extension of the switching ring groove for the axially movable valve ring is large enough to guarantee that the damping medium can flow around the valve ring over a relevant stroke range of the piston rod.

### BACKGROUND OF THE INVENTION

1. Field of the Invention

Disclosed is a vibration damper, and more particularly, a vibration damper with amplitude-selective damping force

2. Description of the Related Art

DE 10 2006 005 935 A1 describes a vibration damper which comprises, in addition to conventional damping valves on the piston, a flow connection between two working spaces, the throttling action of this connection is determined by an axially movable switching ring. The damping force setting is at its minimum value when the switching ring is a certain distance away from the two stop surfaces.

To optimize the distribution of the forces acting on the switching ring, the overall damping device has bypasses in the form of blind bores, which are connected to two nonreturn valves. The nonreturn valves are formed by axially movable valve rings, which execute very short switching movements in their switching ring grooves. Depending on the position into which they are switched, the valve rings release a so-called pilot opening cross section, which determines the damping force present when the switching ring rests against a stop surface.

Extensive driving tests have shown that the valve design described in DE 10 2006 005 935 A1 does not offer an optimum solution. Although the damping force is reduced to a low level when the switching ring assumes, for example, a middle position, this low damping force makes the rolling behavior worse in the case of commercial vehicles. It would be possible to improve this rolling behavior by decreasing the distance between the stop surfaces or by increasing the damping force level. Both of these measures, however, make the ride more uncomfortable.

### SUMMARY OF THE INVENTION

An object of the present invention consists in providing a vibration damper with amplitude-selective damping force of the general type in question in such a way that the conflict between the goal of maximizing the comfort of the ride and the goal of minimizing the rolling behavior is solved.

According to one embodiment of the invention, an axial extension of the switching ring groove for the axially movable valve ring is large enough to guarantee that damping medium can flow around the valve ring over a relevant stroke range of the piston rod.

By using the valve ring as an additional switching ring, there exists the possibility that, in addition to a very soft damping force setting, which is present when the switching ring is a certain distance away from one of the stop surfaces, and in addition to the operating state when the switching ring is resting on a stop surface and the vibration damper is following the normal damping force curve, at least one additional damping force setting is also made available, so that a softer transition between the various regions of the damping force curve regions is achieved. The additional region of the curve with increased damping force prevents unpleasant rolling behavior. The valve ring in DE 10 2006 005 935 A1 has the freedom to move an axial distance of only about 0.5 mm, where this 0.5 mm already includes an allowance for manufacturing tolerances of the valve ring. Thus, the present advantage cannot be realized.

According to one embodiment of the invention, the distance between the lateral surfaces of the groove of the switching ring groove for the valve ring is smaller than the distance between the stop surfaces for the switching ring. With this measure, a compromise is reached between the available space and an increase in the damping force.

It is also provided that a valve ring is available in a switching ring groove outside of each stop surface.

The maximum stroke of the valve ring for a first direction of movement of the piston rod is shorter than the stroke of the valve ring which acts when the piston rod moves in the opposite direction. The switching distances of the valve rings being different lengths is yet another way to achieve an additional damping force setting of the piston arrangement.

For this purpose, an additional pilot opening cross section, which is smaller than the pilot opening cross section controlled by the valve ring, is provided in the bypass.

In one valve design, a nonreturn valve, which, when in the closed position, defines a residual cross section that serves as an additional pilot opening cross section, is installed in the bypass.

There is preferably a bypass for each flow direction of the damping medium, and the switching ring, even when it is resting against a stop surface that keeps the transverse opening proceeding from the bypass partially open, so that damping medium is able to flow toward the closed nonreturn valve via the larger of the two annular spaces and via the open transverse opening to a bypass for the opposite flow direction. The bypasses to the flow connection between the annular spaces can be used for both flow directions, so that the geometry of the piston arrangement overall is simplified.

So that a flow route can be closed to obtain one damping force setting and so that a second flow route can be opened to obtain a different damping force setting, a contact surface between the switching ring and the lateral surface extending between the two stop surfaces is designed to curve in the axial direction of the piston arrangement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is to be explained in greater detail below on the basis of the following description of the figures:

FIG. 1 shows a piston arrangement in the starting position;

FIG. 2 shows a cross section through the arrangement of FIG. 1;

FIGS. 3-8 show individual parts of the piston arrangement according to FIG. 1;

FIGS. 9-16 show the operating behavior of the piston arrangement for a first direction of movement; and

FIGS. 17-23 show the operating behavior of the piston arrangement for a second direction of movement.

### DETAILED DESCRIPTION OF THE PRESENTLY PREFERRED EMBODIMENTS

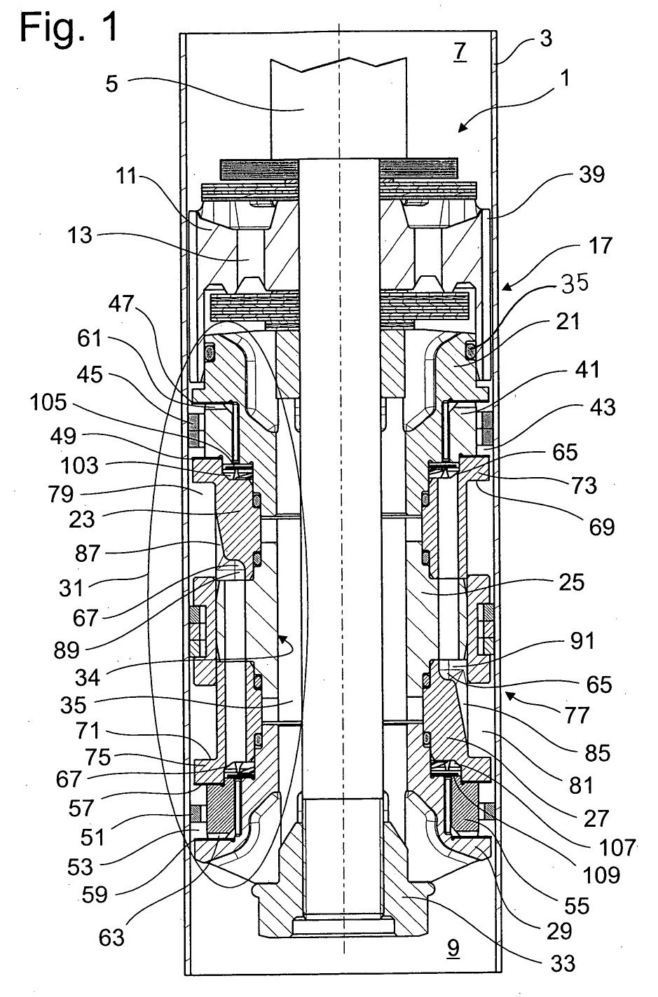

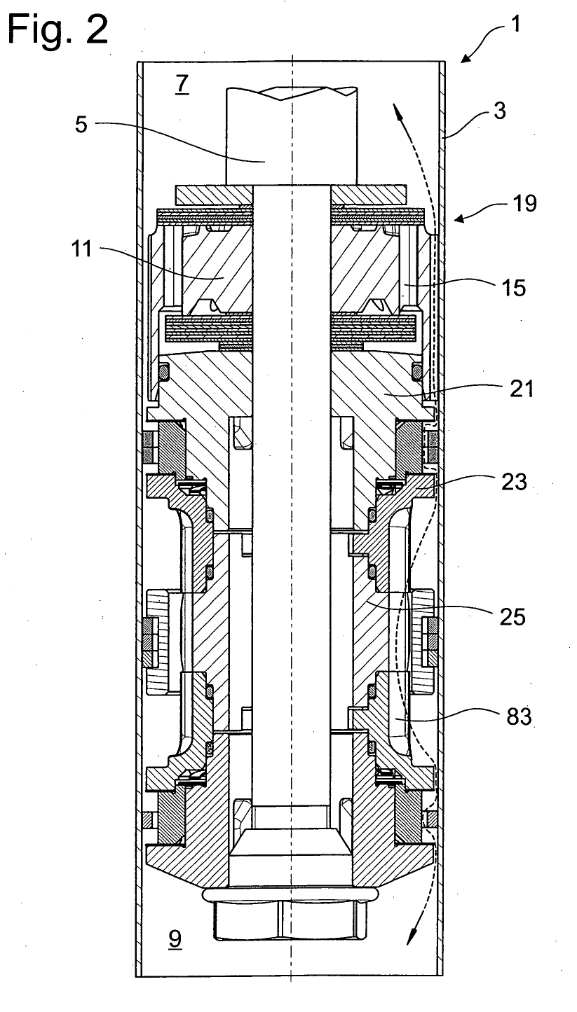

FIGS. 1 and 2 show a piston arrangement 1 inside a damping medium-filled cylinder 3 as part of a vibration damper. It is unimportant whether the vibration damper is designed according to the single-tube or the twin-tube principle. The piston arrangement 1 is attached to a piston rod 5. The piston arrangement 1 divides the cylinder 3 into a working space 7 on the side of the piston with the piston rod and a working space 9 on the side of the piston arrangement 1 opposite the piston rod 5.

A piston 11 inside the piston arrangement 1 has through-channels 13; 15 (FIG. 2), which are equipped with valve disks, so that damping valves 17; 19 are available for both directions of flow.

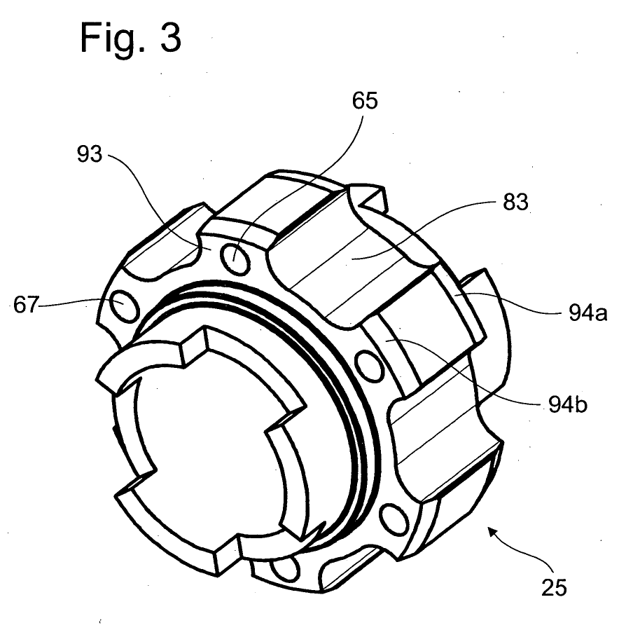

In addition to the piston 11, the piston arrangement comprises, in series, a distributor ring 21 (FIGS. 1, 6-8), a first head part 23 (FIGS. 1, 4 and 5), a spacer sleeve 25 (FIGS. 1 and 3), a second head part 27, and a clamping sleeve 29. Components 21-29 form an assembly 31 for generating an amplitude-selective damping force through which the piston rod 5 passes through. At least the two head parts 23 and 27 are preferably designed as identical parts. A piston nut 33 holds the assembly 31 axially in position. The piston rod 5 and the inner lateral surface 34 of the assembly 31 form an annular space 35 for the exchange of damping medium via the damping valves 17 and 19 between the two working spaces 7 and 9, where flow-through windows 37 for the damping medium are provided in the clamping sleeve 29.

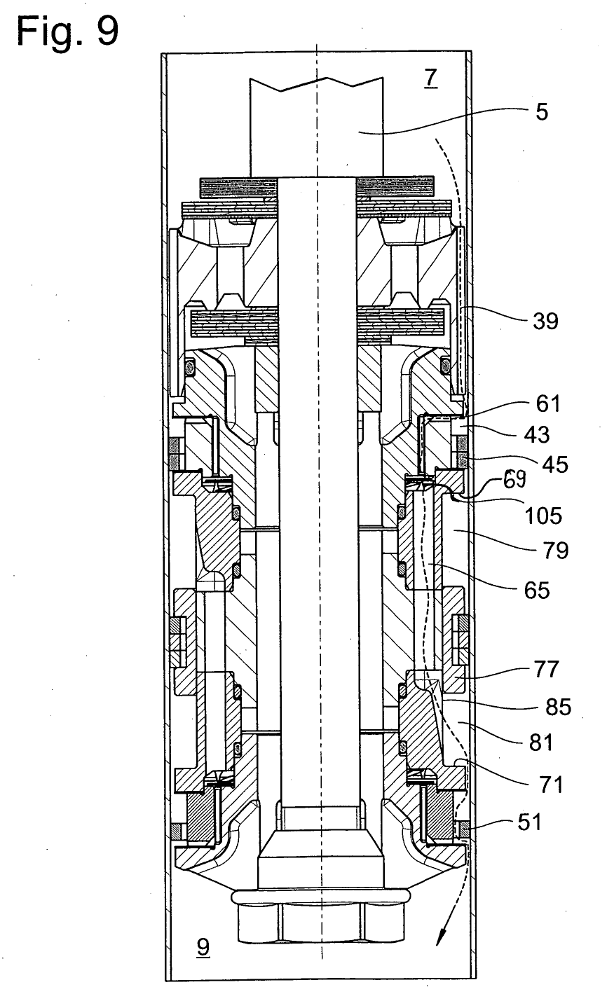

A flow connection 39, which in one embodiment are axial channels in the lateral surface of the piston 11, is provided hydraulically parallel to the damping valves 17 and 19. An intermediate ring 41, which determines the height of a switching ring groove 43 for a first axially movable valve ring 45, is clamped between the distributor ring 21 and the first head part 23. Pilot opening disks 47 and 49 with different sets of recesses in their edges are arranged on both sides of the intermediate ring 41. A similar design of an axially movable valve ring 51 in a switching ring groove 53, which is formed by an intermediate ring 55 and pilot opening disks 57 and 59, provided between the second head part 27 and the clamping sleeve 29. Each switching ring groove 43 and 53 has a respective connection 61 and 63 to a respective channel 65 and 67, formed in part by the head parts 23 and 27 and in part by the spacer sleeve 25. (FIG. 9).

The two head parts 23 and 27 have stop surfaces 69 and 71 on their ring-shaped webs 73 and 75, where an axially movable switching ring 77 slides along the head parts 23 and 27 and the spacer sleeve 25. The switching ring 77 cooperates with the stop surfaces 69 and 71 to form the boundaries of annular spaces 79 and 81, the axial dimensions of which change as a function of the switching position of the switching ring. The two annular spaces 79 and 81 are connected to each other by axial connecting grooves 83 in the outer lateral surfaces of the head parts 23 and 27 and of the spacer sleeve 25, which make it possible for damping medium to flow under the switching ring 77 (FIG. 2).

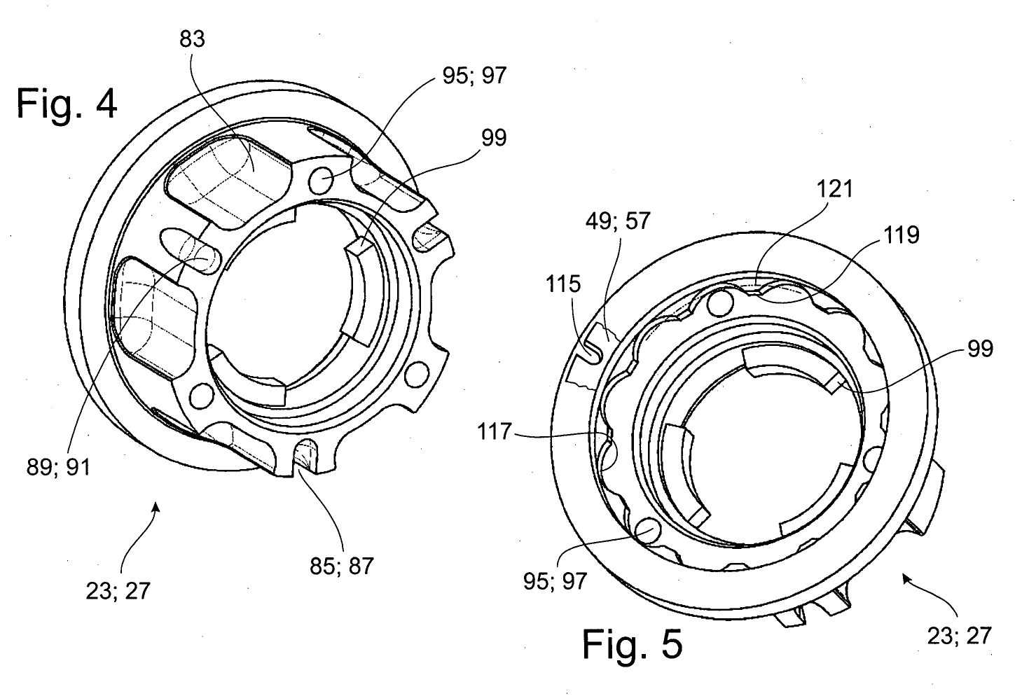

Each head part 23 and 27 has at least one transverse opening 85 and 87. These openings are connected to blind hole-like channels 89 and 91 alternating around the circumferences of the two head parts. In this exemplary embodiment, as can be seen from the diagrams of the spacer sleeve 25 and the head parts 23 and 27 in FIGS. 3 and 4, three blind hole-like channels 89 and 91 are used for the inward travel movement of the piston rod toward the working space 9, and three channels 91 are used for the outward travel movement of the piston rod. The spacer sleeve 25 has on its lateral surface axial webs 93 for the channels 65, where the connecting grooves 83 between the webs 93 can also be seen. As a result, the spacer sleeve acquires a contour similar to that of a gear wheel. A contact surface 94 for the switching ring 77 is thus present between the two stop surfaces 69 and 71. As a result of the bevels 94a; 94b, this surface acquires a curvature extending in the axial direction of the piston arrangement.

For each direction of movement, through-openings 95 and 97 and the blind hole-like channels 89 and 91 are alternately formed with each other in the head parts 23 and 27. The blind hole-like channels proceed from the end surface of the head part facing the spacer sleeve 25 and lead to the transverse openings 85 and 87. The cross sections of the transverse openings 85 and 87 decrease as they proceed toward the adjacent stop surface. The channels 65 and 67 form a bypass channel leading around the connecting grooves 83 between the annular spaces 79 and 81.

The distributor ring 21 and the first head part 23 form an annular space 103 (FIG. 1), in which a nonreturn valve 105 is installed, which allows the inflow of damping medium into the first head part 23. The second head part 27 and the clamping sleeve 29 also form a similar annular space 107, in which a nonreturn valve 109 is also installed, which makes it possible for damping medium to flow into the channels 67.

FIG. 5 shows one embodiment of the pilot opening disk 49 and 57 (FIG. 1) with its pilot opening cross section 115 as part of the switching ring groove. The pilot opening disk 49 lies on an end surface which faces the distributor ring 21, and the pilot opening disk 57 lies on an end surface which faces the clamping sleeve 29. Adjoining this end surface is a graduated pass-through opening with a wave-like contact profile 117. The inside diameter forms centering surfaces 119 for the disk-shaped spring of one of the nonreturn valves 105 and 109 (FIG. 1). The top surface 121 of the contact profile serves as a boundary surface for limiting the lift of the valve disk of the associated nonreturn valve 105 and 109, the outside diameter of which, shown in broken line, is smaller than the maximum radial extension of the wave profile, so that, in the maximum open position of the nonreturn valve, a plurality of through-openings, each with a cross section in the form of part of a circle, is present.

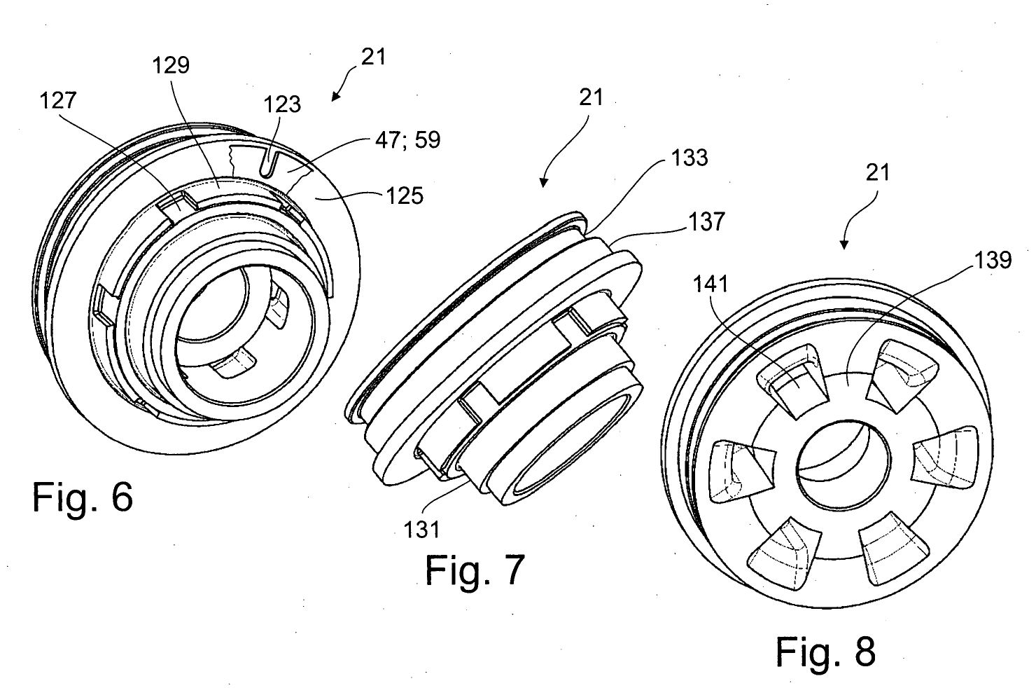

FIGS. 6-8 show the distributor ring in isolation. FIG. 6 shows a part of the pilot opening disk 47 and 59 with its pilot opening cross section 123. The disk is clamped to a contact surface 125. Several grooves 127, which form part of the connections 61 (FIG. 1) leading to the nonreturn valve 105, are preferably machined into the circumference of an axial shoulder behind the contact surface. The shoulder serves as the centering surface 129.

FIG. 7 shows a second shoulder, which forms a centering surface 131 for the valve disk of the nonreturn valve 105. This centering surface 131 serves the same purpose for the first head part 23. At the other end, the distributor ring 21 has an annular groove 133 to accept a seal 135 (FIG. 1) and a centering surface 137 for the piston 11.

FIG. 8 shows the top surface of the distributor ring 21 with a clamping surface 139 for the valve disks of the damping valve 17 mounted on the piston and with through-openings 141 leading to the piston valves 17 and 19.

FIG. 1 shows the piston arrangement 1 with the ideal central starting positions of the switching ring 77 between the stop surfaces 69 and 71 and of the two valve rings 45 and 51 in the switching ring grooves 43 and 53. In this state of the piston arrangement, as shown in FIG. 2, the damping medium can flow, independently of the direction in which the piston rod is moving, via the flow connection 39, along the switching ring groove 43, through the annular spaces 79 and 81 and the switching ring groove 53. The flow connection just described has the effect of producing the softest damping force setting of the piston arrangement, a setting in which the damping valves 17 and 19 are still closed.

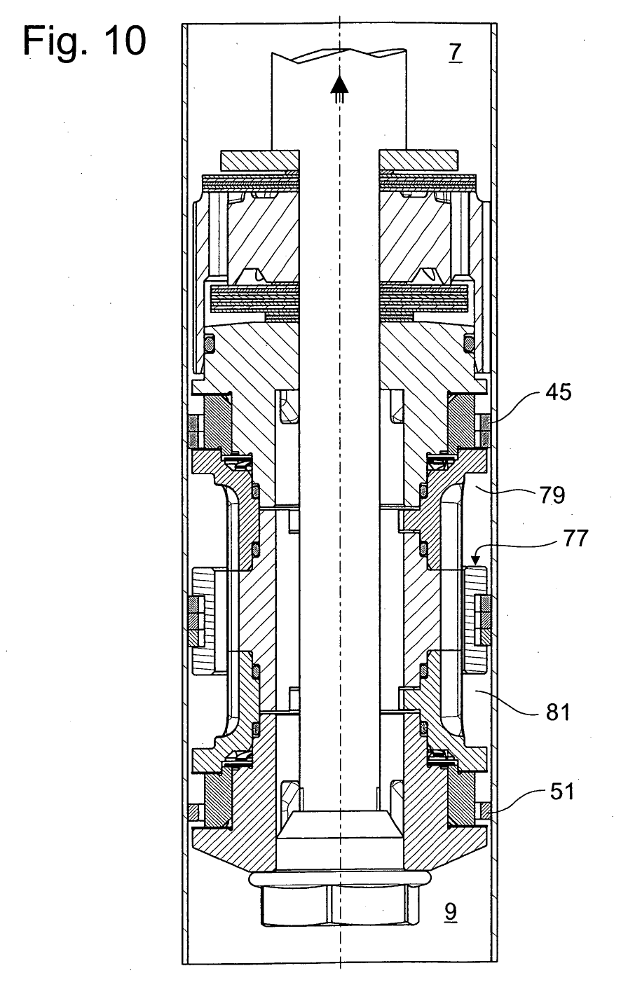

In FIGS. 9 and 10, the piston rod 5 is moving toward the working space 7. The valve ring 45 is already resting on the lateral wall of the switching ring groove 43 and, except for a small pilot opening cross section, blocks off the flow of damping medium via the switching ring groove into the annular space 79. Although the switching ring 77 and the valve ring 51 have moved toward the working space 9 relative to the piston arrangement 1, they are not yet resting against, respectively, the stop surface and the lateral wall of the switching ring groove. The damping medium follows the route, shown in broken line, which proceeds via the flow connection 39 to the connection 61, through the opened nonreturn valve 105, and then into the channel 65. The flow then proceeds from the transverse openings 85 to the annular space 81, from which the route continues through the switching ring groove 53, as the broken line illustrates. The damping force is determined by the throttling resistance of the flow route extending from the connection 61 to the channel 65, because, when the piston rod moves, the entire volume of damping medium must flow through these cross sections, which are narrower than the more open route present in the switching position according to FIG. 1.

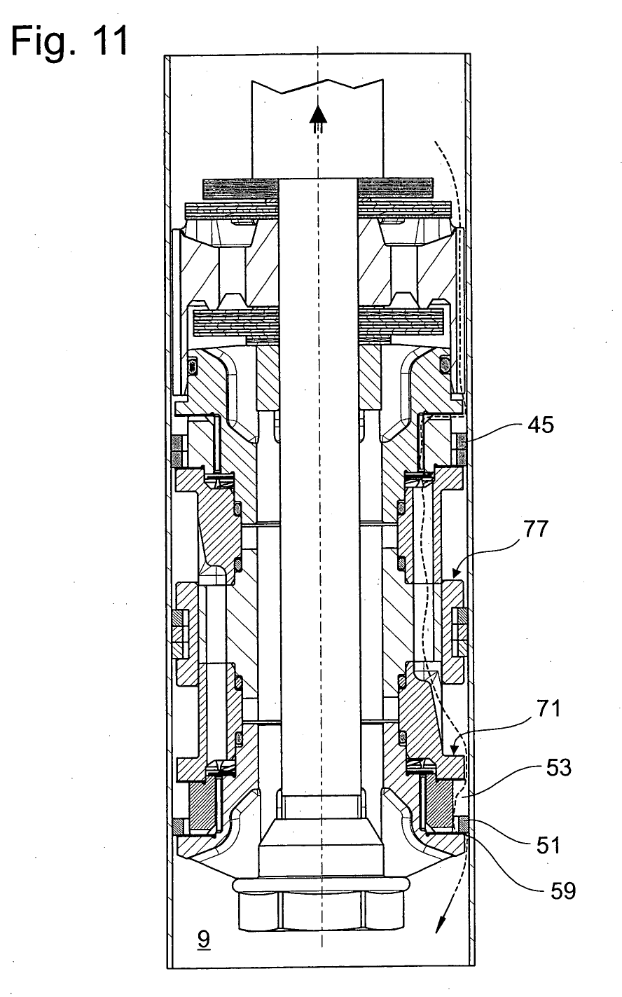

As the course of the stroke continues, as shown in FIG. 11, the valve ring 51 also reaches the lateral surface of the switching ring groove 53 closer to the working space 9, whereas the switching ring 77 still is still a certain distance from the stop surface 71. The flow route of the damping medium corresponds to the description provided for FIG. 9. The throttling resistance is now determined, however, by the pilot opening disk 59 in the switching ring groove 53, so that, for the same velocity of piston rod movement, the damping force is now greater than that present in FIGS. 9 and 10.

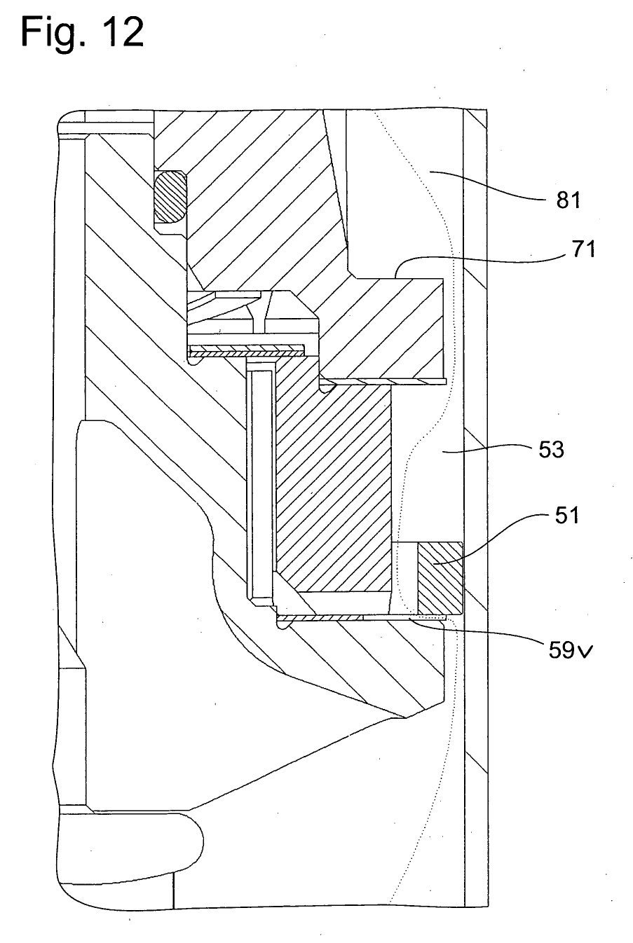

FIG. 12 shows an enlarged view of the area around the switching groove 53. The flow route is again illustrated by a broken line. Even when the valve ring 51 is resting against the pilot opening disk 59, the pilot opening 59v is present.

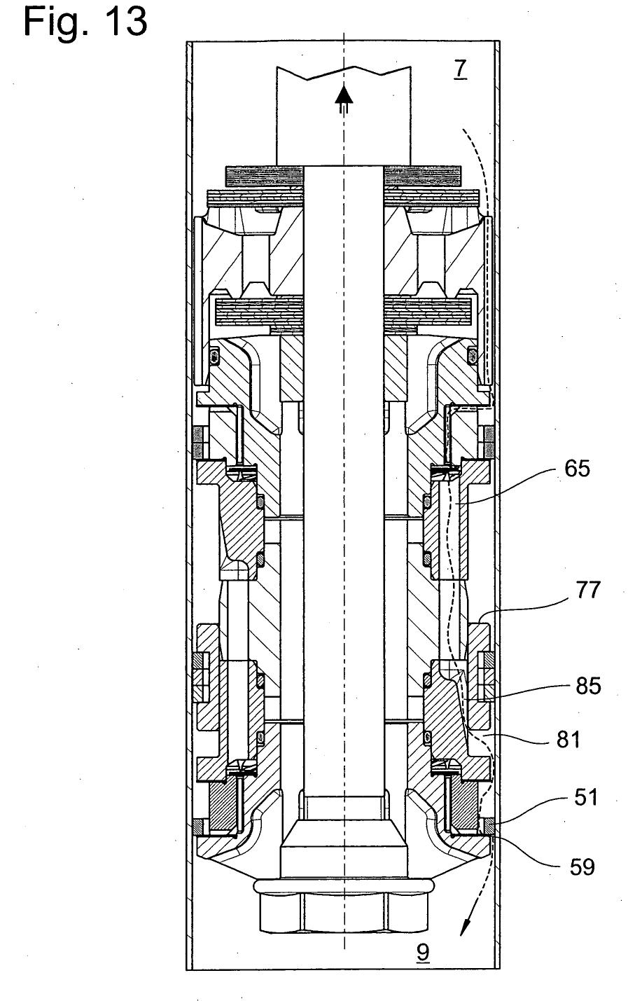

FIG. 13 shows the piston rod arrangement 1 in a stroke phase in which the switching ring 77 is in the process of closing the transverse opening 85, which connects the channel 65 to the annular space 81. The pilot opening disk 59, as FIG. 12 shows, has a larger throttling cross section 59v than the now-active cross section of the transverse opening 85, so that the transverse opening 85 now determines the effective damping force.

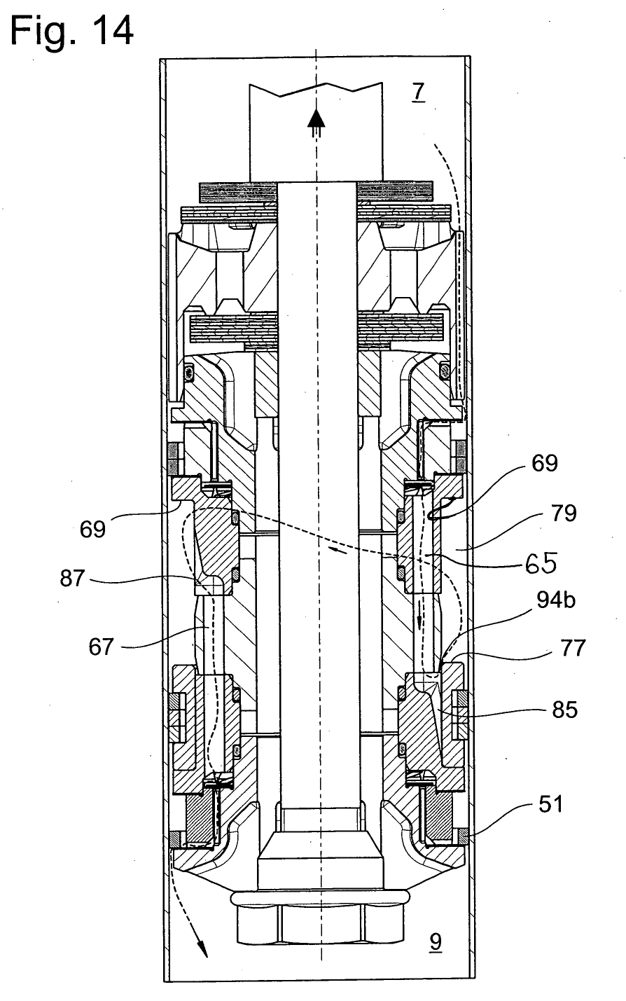

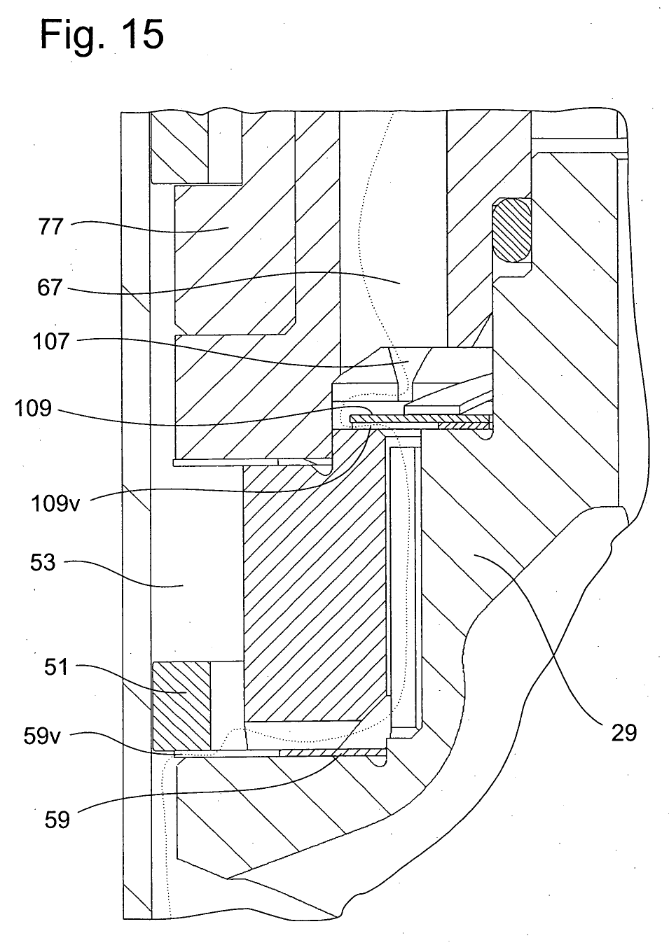

In FIG. 14 the switching ring 77 closes the transverse opening 85, referred to below simply as 85, at the point where it leads out into the annular space 81 and thus prevents (FIG. 13) damping medium from flowing toward the valve ring 51. The flow route from the channel 65 into the annular space 79 is now open, because the bevel 94b, which acts as a contact surface with the switching ring 77, has a curved design and therefore allows the damping medium to flow under the switching ring (FIG. 14), even after the switching ring 77 has come to rest against the stop surface 71. The piston arrangement 1 has a bypass in the form of a channel 65 for each flow direction of the damping medium, and the damping medium can thus flow from the unclosed transverse opening 85 via the annular space 79 to the area of the stop surface 69 and thus to a bypass 67, which is also provided for guiding the flow of damping medium during a movement of the piston rod in the direction toward the working space 9. The damping medium continues as far as the closed nonreturn valve 109, which is installed in the bypass 67 and which, even when in the closed position, provides a residual cross section serving as an additional pilot opening cross section 109v, which is smaller in turn that the pilot opening cross section 59v of the pilot opening disk 59 (FIG. 15). Thus the damping force is increased yet again even though the velocity of the piston rod has not changed.

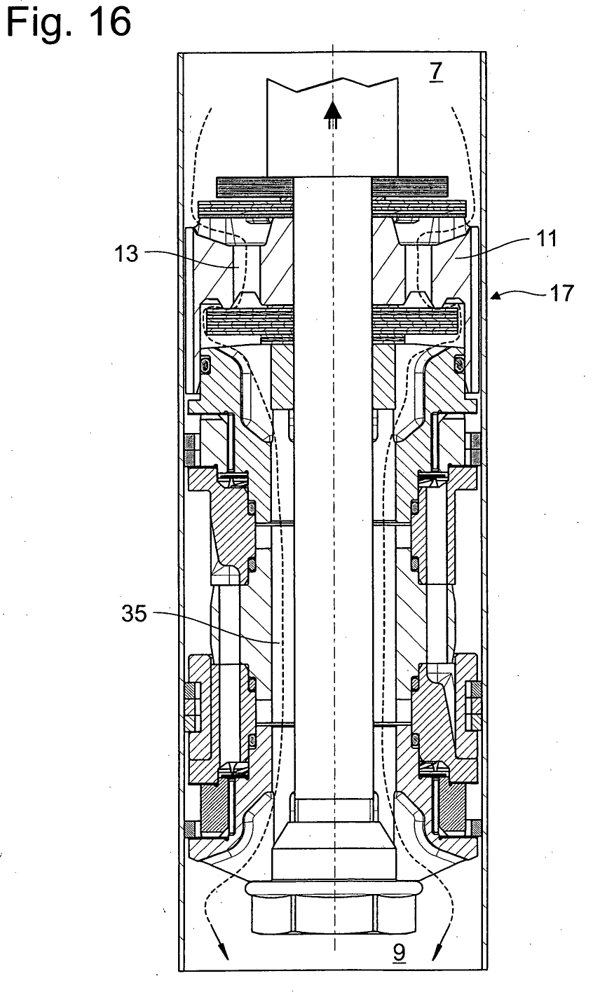

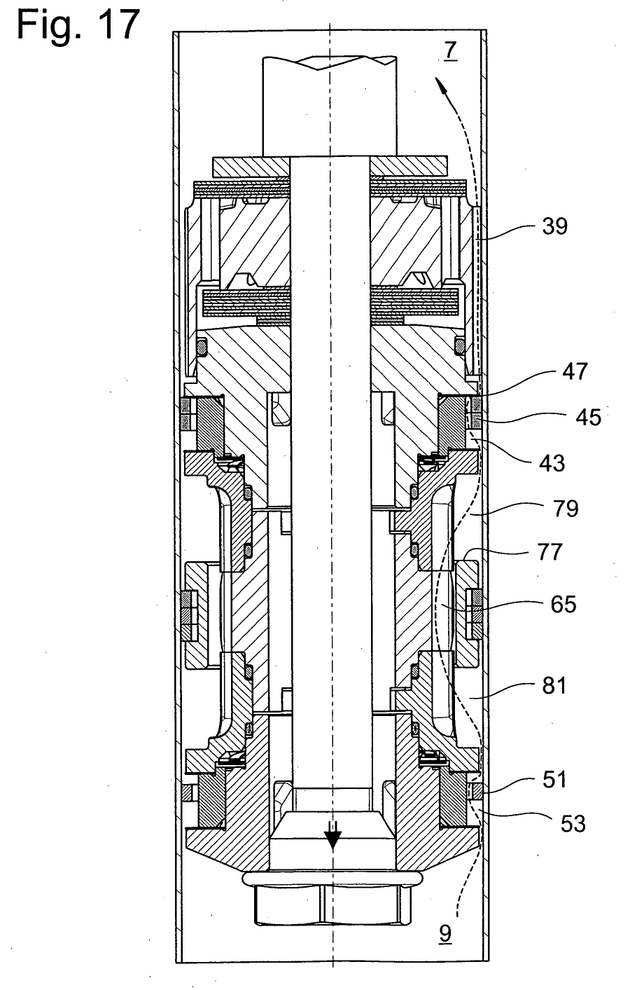

FIG. 16 describes the situation which exists when the piston arrangement has traveled the same distance as in the sequence according to FIGS. 1-15 but the piston velocity has exceeded a defined level and thus generates an opening force on the damping valve 17 in the piston 11. Damping medium now flows through the through-channels 13, along the damping valve 17, and into the annular space 35. From there, it flows into the working space 9. The hardest damping force setting is now present in the piston arrangement 1.

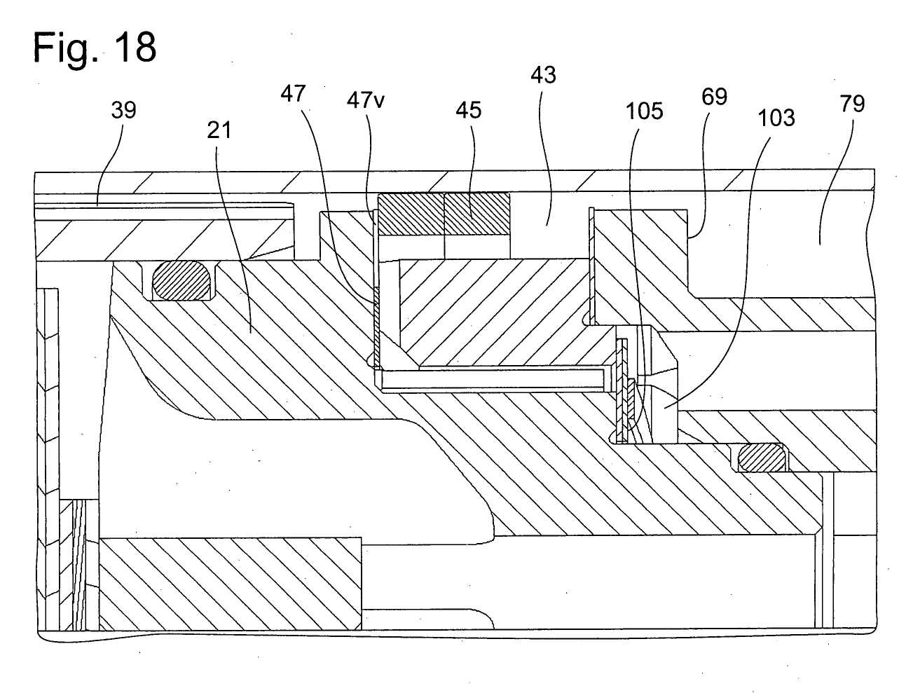

With respect to the flow routes inside the assembly 31 (see FIG. 1), the piston arrangement 1 is preferably designed with mirror-image symmetry. Proceeding from FIG. 1, in which the softest damping force setting is present, the piston rod 5 moves toward the working space 9. As this is happening, the valve ring 45 slides inside the switching ring groove 43. FIG. 18 shows an enlarged view of the area around the valve ring 45. The damping medium flows via the switching ring groove 53 and the annular spaces 81 and 79 into the switching ring groove 43. The pilot opening cross section 47v in the pilot opening disk 47 on the distributor ring 21 determines the damping force, where the damping medium can now flow onward via the flow connection 39 into the working space 7.

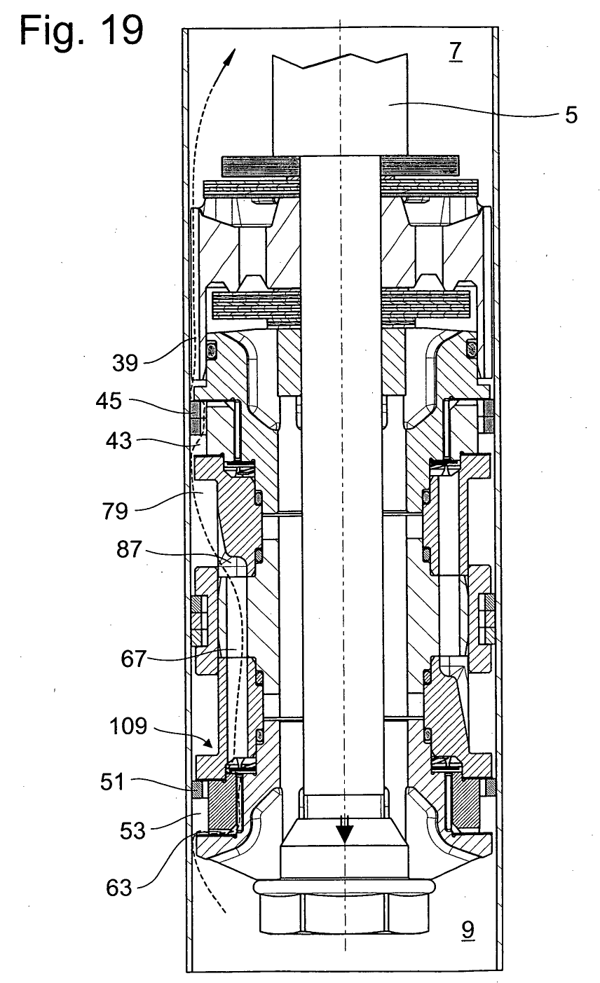

In FIG. 19, the two valve rings 45 and 51 are resting on the lateral surfaces of the grooves closer to the working space 7. The damping medium flows through the connection 63 along the opened nonreturn valve 109, and into the bypass 67, then via the transverse opening 85 and the annular space 79 into the switching ring groove 43. The throttling resistance in the area between the connection 63 and the nonreturn valve 109 is added to the throttling resistance of the pilot opening cross section 47v (FIG. 18), so that the damping force is increased again without any change in the velocity of the piston rod.

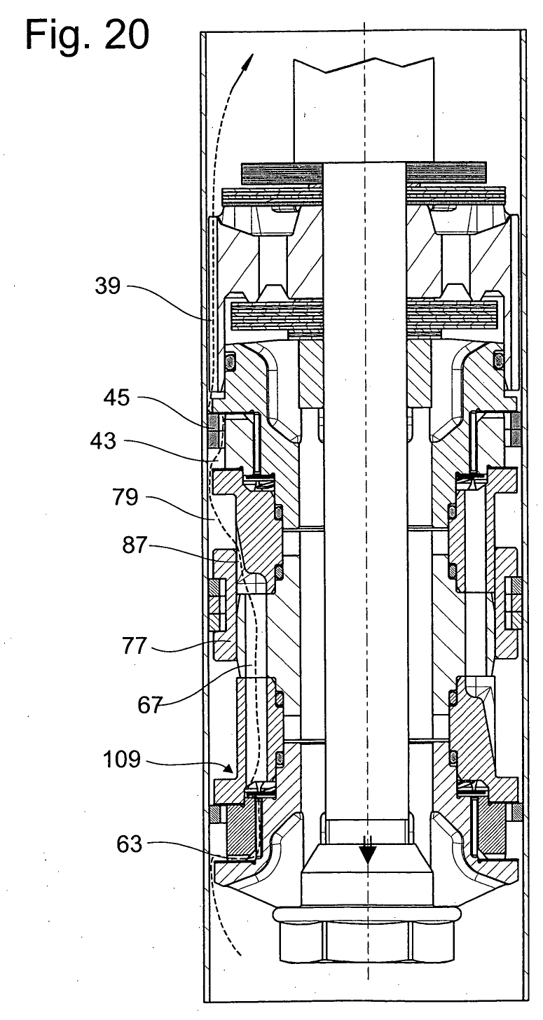

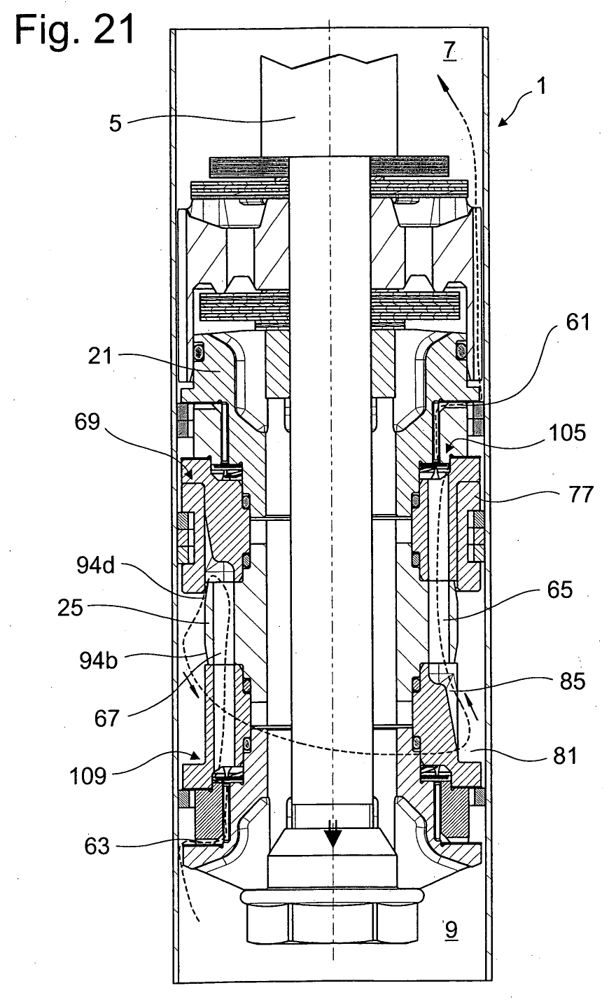

In FIG. 20, the switching ring 77 has already partially closed the transverse opening 87, so that, although the flow route according to FIG. 19 is still present, a slide valve, formed by the switching ring 77 in conjunction with the transverse opening 87, acts as a throttle, which raises the damping force level even though the velocity of the movement of the piston rod has not changed.

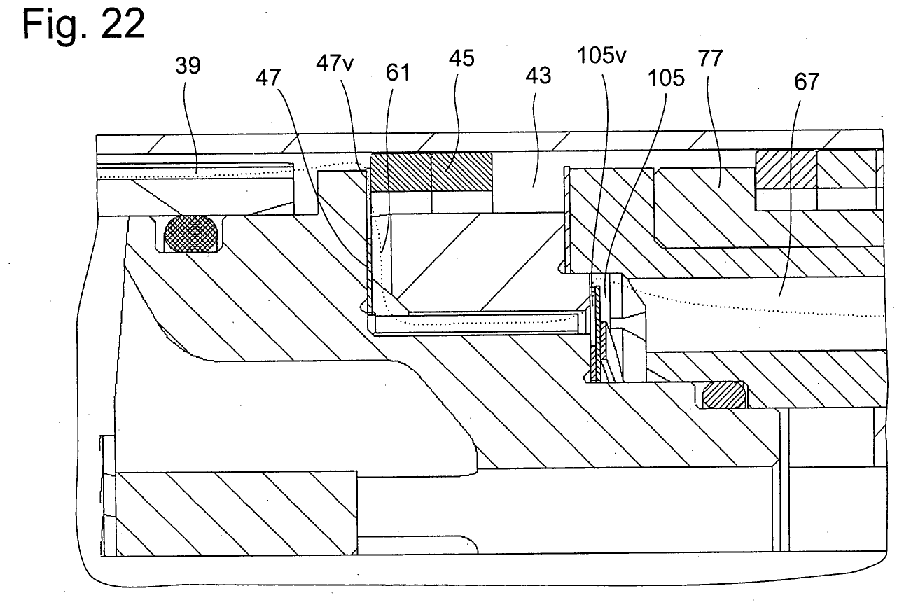

As the piston continues to move in the direction of the arrow, the switching ring 77 comes to rest against the stop surface 69. Thus the direct route via the bypass 67 into the annular space 79 is no longer available. The damping medium, however, can still flow along the bevel 94d on the spacer sleeve 25 in the area of the contact surface with the switching ring 77 and thus reach the annular space 81. From there it flows into the transverse opening 87, shown in FIGS. 9-13 for the pulling direction of the piston rod, and thus enters the bypass channel 67, heading in the direction toward the nonreturn valve 105 on the distributor ring 21. The nonreturn valve 105 is not hermetically sealed but rather, as FIG. 22 shows, has a pilot opening cross section 105v, which is formed by a cut-out area in the valve disk. Thus the damping medium can flow from the working space 9 into the connection 63, then via the open nonreturn valve 109 into the bypass channel 67 and along the bevel 94a into the annular space 81. The rest of the flow route is now available, i.e., the route proceeding via the transverse opening 87 into the bypass channel 65, through the pilot opening cross section 105v of the closed nonreturn valve 109, then into the connection 61 and thus into the pilot opening cross section 47v of the pilot opening disk 47 leading to the flow connection 39 on the lateral surface of the piston, where the additional pilot opening cross section 109v brings about another increase in the damping force action of the piston arrangement 1 without any change in the velocity of the movement of the piston rod.

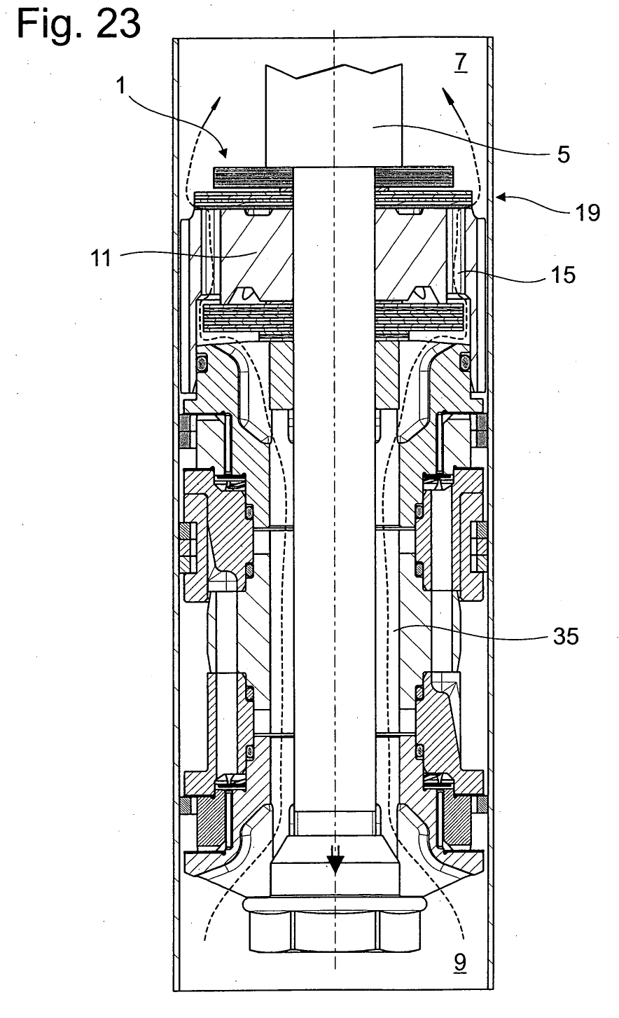

The piston arrangement 1 achieves its maximum damping force action in FIG. 23. The damping medium flows for the most part from the working space 9 into the annular space 35, from which it continues to the pass-through channels 15 in the piston 11, so that the damping valve 19 opens.

Through the use of the valve rings 45; 51 as additional switching rings, it is possible to achieve a multi-stage increase in the damping force of the piston arrangement, so that a nearly continuous transition from the softest to the hardest damping force setting is possible. A comfortable damping force setting therefore remains available, but at the same time an overall damping force characteristic is obtained which takes the safety aspect into account.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A vibration damper having amplitude-selective damping force, comprising:
a cylinder filled with a damping medium;
a piston rod configured for axial movement in the cylinder;
a piston arrangement attached to the piston rod, the piston arrangement dividing the cylinder into a first working space and a second working space;
a flow connection between the first work space and the second work space, the damping force based at least in part on the flow connection;
an axially moveable switching ring axially moveably mounted on the piston arrangement for movement between a first stop surface and a second stop surface;
a first annular space bounded by the switching ring the first stop surface adjacent the first work space;
a second annular space bounded by the switching ring the second stop surface adjacent the stop work space;
first and second switching ring grooves, each having an axial extension bounded by respective lateral surfaces; and
a first valve ring in the first switching ring groove;
wherein the damping force is based at least in part on the movement of the piston rod, the switching ring, and the first valve ring and
wherein the axial extension of each of the switching ring grooves is large enough to guarantee that the damping medium flows around the valve ring over a relevant stroke range of the piston rod.

2. The vibration damper according to claim 1, wherein the distance between the lateral surfaces of the switching ring grooves is shorter than the distance between the stop surfaces for the switching ring.

3. The vibration damper according to claim 1, further comprising a second valve ring in the second switching ring groove.

4. The vibration damper according to claim 3, wherein a maximum stroke distance of at least one of the first and second valve rings for a first direction of movement of the piston rod is shorter than a stroke distance at least the other of the first and second valve rings which acts during movement of the piston rod in an opposite direction.

5. The vibration damper according to claim 1, wherein a bypass to the flow connection controlled by the switching ring comprises a pilot opening cross section controlled by the switching ring that is smaller than a pilot opening cross section controlled by the first valve ring.

6. The vibration damper according to claim 5, wherein the bypass comprises a nonreturn valve, the nonreturn valve having a residual cross section in a closed position, the residual cross section serving as an additional pilot opening cross section.

7. The vibration damper according to claim 6, wherein the bypass is present for each flow direction of the damping medium, and when the first switching ring is in contact with the stop surface a transverse opening is partially open such that the damping medium can flow via the larger of the two annular spaces and the transverse opening to the bypass for the opposite flow direction leading to the nonreturn valve, the nonreturn valve being in a closed position.

8. The vibration damper according to claim 7, wherein a contact for the first switching ring between the two stop surfaces is configured with a curvature in the axial direction of the piston arrangement.

9. The vibration damper according to claim 1, wherein the first working space is on the piston rod side of the piston and a second working space is on the side of the piston opposite the piston rod

10. The vibration damper according to claim 1, wherein the first valve ring is adapted to move at least 5 mm.
